(19) United States
(12) Patent Application Publication
(10) Pub. No.: US 2025/0156733 A1
(43) Pub. Date: May 15, 2025

(54) STORING LEARNED EMBEDDINGS OF SEQUENCE STATES

(71) Applicant: STRIPE, INC., South San Francisco, CA (US)

(72) Inventor: Sai Kiran Burle, Redwood City, CA (US)

(21) Appl. No.: 18/388,403

(22) Filed: Nov. 9, 2023

(51) Int. Cl. G06N 5/022

(52) U.S. Cl. CPC G06N 5/022

(57) ABSTRACT

A method for computing a prediction using a machine learning model includes: receiving a current data sample of a sequence of data samples; retrieving, from a data store, a state value representing a learned embedding of previous samples of the sequence of data samples; computing, by a recurrent neural network, based on the current data sample and the state value: an output value representing an inference regarding the current data sample; and an updated state value representing a learned embedding of the current data sample and the previous samples of the sequence of data samples; storing the updated state value in the data store; and outputting the output value regarding the current data sample.

### BACKGROUND

A machine learning model that depends on a sequence of data samples is referred to as a sequence model. One example of a sequence model is a recommendation for a next video to show a user based on a sequence of videos that the user previously watched (e.g., the last twenty videos watched by the user).

The above information disclosed in this Background section is only for enhancement of understanding of the present disclosure, and therefore it may contain information that does not form the prior art that is already known to a person of ordinary skill in the art.

### SUMMARY

The preset disclosure is directed to storing learned embeddings of sequence states as shown in and/or described in connection with at least one of the figures, as set forth more completely in the claims.

### BRIEF DESCRIPTION OF THE DRAWINGS

The accompanying drawings, together with the specification, illustrate exemplary embodiments of the present invention, and, together with the description, serve to explain the principles of the present invention.

FIG. 1A is a block diagram illustrating a system including a sequence machine learning model and a sequence model state data store, according to one embodiment of the present disclosure.

FIG. 1B is a graphical depiction of multiple dimensions of sequence data using a credit card transaction as an example of a current data sample and where a credit card number and a merchant identifier are used as different dimensions, according to one embodiment of the present disclosure.

FIG. 2 is a flowchart of a method for using a sequence model state data store with a sequence machine learning model, according to one embodiment of the present disclosure.

FIG. 3 is a flowchart of a method for using a sequence model state data store with a sequence machine learning model, according to one embodiment of the present disclosure.

FIG. 4 is a flowchart of a method for updating a sequence model data store based on an updated sequence model, according to one embodiment of the present disclosure.

FIG. 5 is a block diagram illustrating a high-level network architecture of a computing system environment for operating a processing system according to embodiments of the present disclosure.

FIG. 6 is a block diagram illustrating a representative software architecture, which may be used in conjunction with various hardware architectures as described herein.

FIG. 7 is a block diagram illustrating components of a processing circuit or a processor, according to some example embodiments, configured to read instructions from a non-transitory computer-readable medium (e.g., a non-transitory machine-readable storage medium) and perform any one or more of the methods discussed herein.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Like reference numerals designate like elements throughout the specification.

Sequence machine learning models or sequence models compute inferences or make predictions based on a sequence of events. For example, a sequence model may be trained to generate video recommendations for a given user based on the previous videos watched by the user (e.g., several home improvement videos in a user's viewing history may cause the sequence model to recommend other home improvement videos). Similarly, a sequence model may be trained to generate advertising recommendations or product recommendations for a given consumer (identified by a unique consumer identifier) based on a sequence of previous purchases made by that consumer (e.g., previous transactions associated with that unique consumer identifier). As another example, machine leaning models for credit card fraud detection may generate a confidence or likelihood as to whether a given transaction using a particular credit card number is fraudulent based on a history of prior transactions associated with that credit card number, and subsequently approve or deny the transaction, or generate alerts regarding the activity associated with the credit card number.

One class of sequence machine learning models is a recurrent neural network (RNN). An RNN is a neural network that is intentionally run multiple times, once for each data sample in an input sequence of data samples, where internal state data or state value from a previous run is supplied as input to the next run of the RNN. More specifically, a neural network includes a plurality of neurons organized into layers. An input layer of neurons receives an input data sample (e.g., a vector of features extracted from the data sample, where the features may be represented as numerical values such as floating point or integer values). Each neuron in a given layer connects to neurons in a next layer (or downstream layer) of the neural network, where the neuron applies an activation function (e.g., a rectified linear unit function or logistic activation function) to the sum of the values of its inputs and the output or activation of the neuron is multiplied by a weight associated with the connection between that neuron and another neuron in a downstream layer of the neural network. The output of the neural network is taken from the activations of the neurons of a final, output layer of the neural network. Layers of neurons between the input layer and the output layer are referred to as hidden layers, where a neural network that has more than one hidden layer is referred to as a deep neural network. During a training process, training data is supplied to the input layer and the output of the output layer is compared to training labels associated with the training data. The neural network is trained to generate outputs that match the training data by updating the parameters of the neural network (e.g., the weights of the connections) to reduce or minimize the difference between the output of the neural network and the training labels by backpropagation of the differences from the output layer to the input layer and adjusting the weights accordingly.

In an RNN, the activations of the hidden layers are also supplied as inputs to the hidden layers during the next run of the RNN. These internal values that are propagated between runs are referred to as the state or state value of the RNN, where the state value is updated during each run of the RNN based on the corresponding input data sample from the sequence that is supplied to the RNN. In some embodiments, the state value is represented as a vector of numerical values such as floating point or integer values, and therefore may be referred to as an embedding in a multi-dimensional latent space. As such, the state value of the RNN can be interpreted as a representation of all of the data samples supplied to the RNN thus far, where the state value has a fixed size (e.g., based on the number of different connections from one run of the RNN to the next run of the RNN) that is independent of the number of data samples of the sequence that have been supplied to the RNN. Recurrent neural networks have numerous variants, including fully recurrent neural networks (FRNN), long short-term memory (LSTM) networks, gated recurrent units (GRUs), and the like.

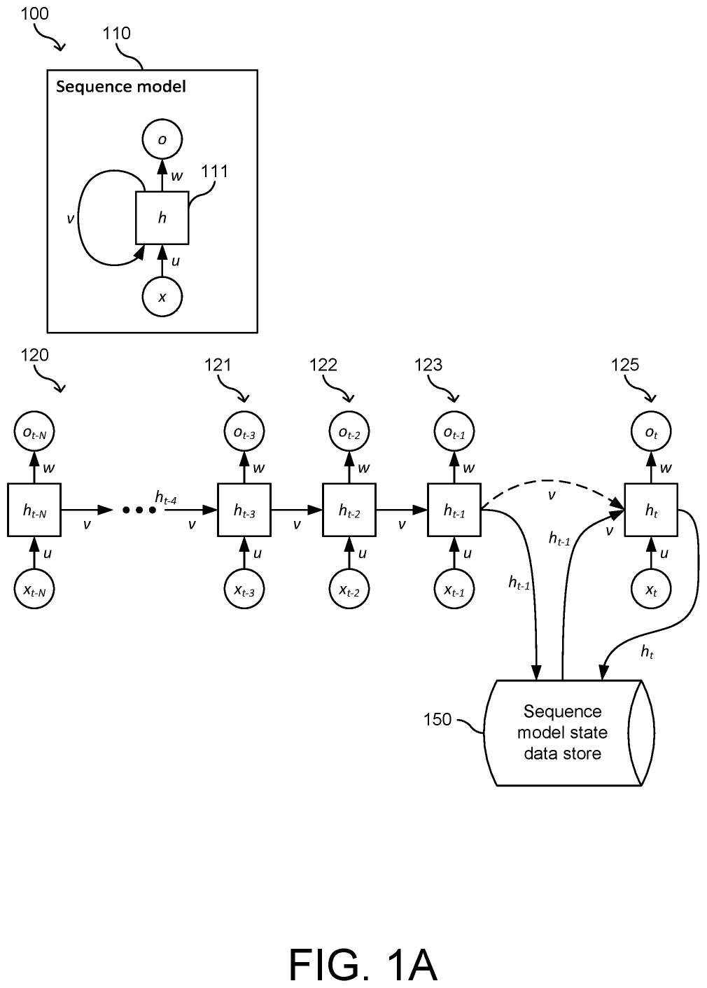

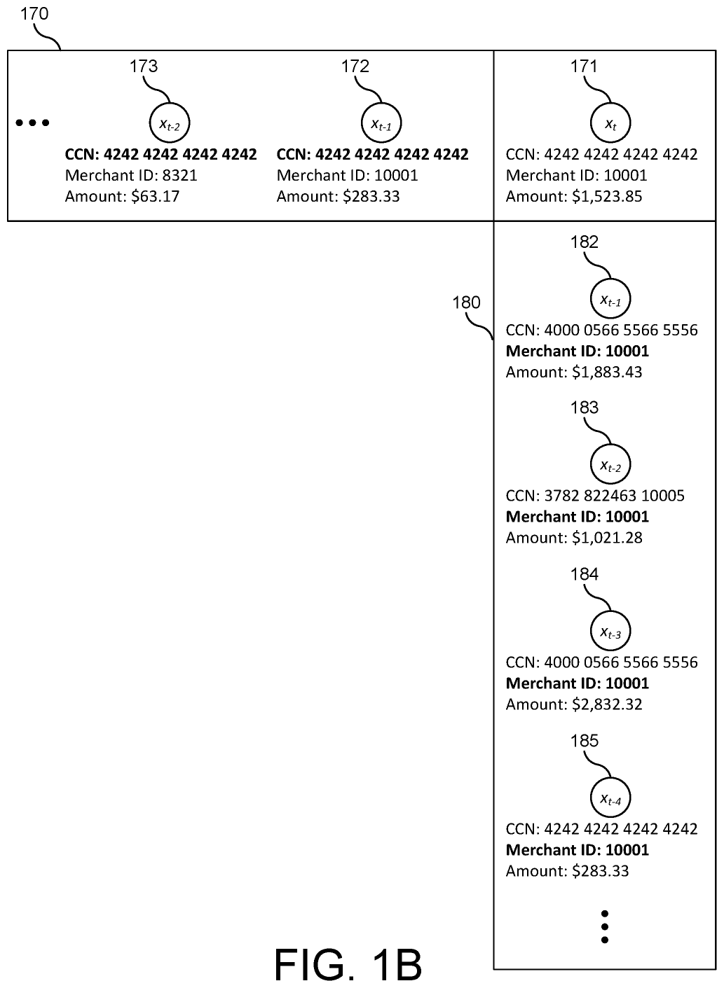

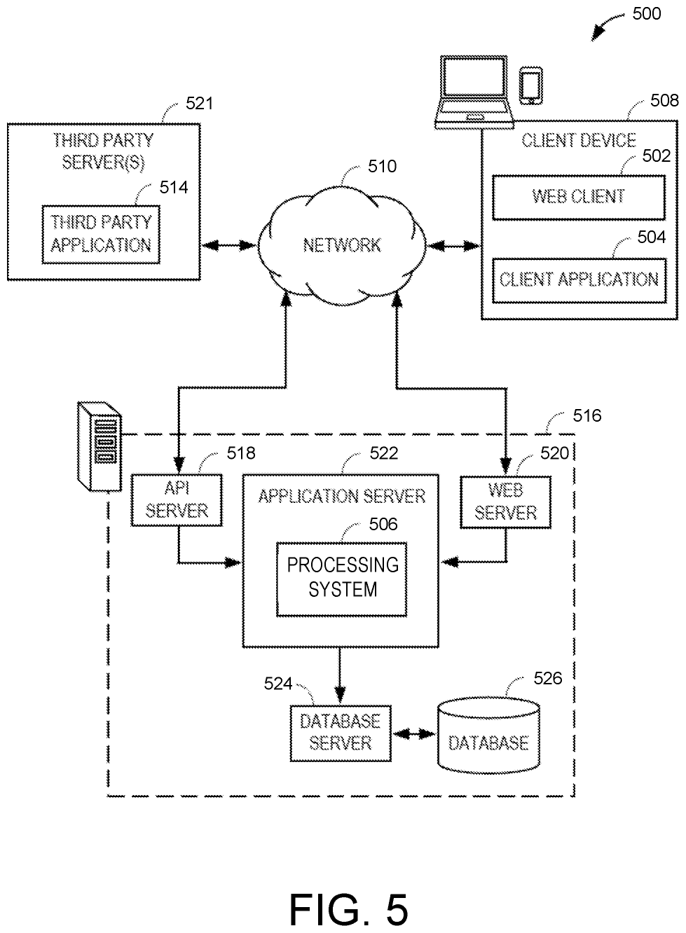

FIG. 1A is a block diagram illustrating a system 100 including a sequence machine learning model 110 and a sequence model state data store 150, according to one embodiment of the present disclosure. The sequence machine learning model 110 is illustrated in FIG. 1A as being implemented by a recurrent neural network, which takes input x corresponding to a current data sample of a sequence, and supplies input features x, scaled by input weights u, to a trained neural network 111 along with an internal state value h from a previous run of the neural network (e.g., where the internal state value h is a vector of numerical values in a multi-dimensional latent space), scaled by weights v. The trained neural network produces activations that scaled by output weights w to generate output o. The neural network is configured by parameters (e.g., weights of the connections between the neurons of the hidden layers), where the parameters were learned during a training process using training data. The sequence machine learning model 110 may be implemented on one or more processing devices or processing circuits of a computer system, such as computer systems described in more detail below in reference to FIGS. 5, 6, and 7. The one or more processing devices may include one or more central processing units (CPUs), one or more graphics processing units (GPUs), digital signal processing units (DSPs), field programmable gate arrays (FPGAs), one or more specialized neural accelerator processing units (e.g., artificial intelligence accelerators), and the like. In the case of multiple processing devices, the processing devices may be located in a single computer or distributed across multiple computers connected over a data link such as Ethernet, compute express link (CXL), and the like.

Continuing the above example, when analyzing a probability or confidence or likelihood that a given credit card transaction on a credit card number is fraudulent, that credit card transaction is the latest transaction in a sequence of transactions associated with that credit card number. Accordingly, when using an RNN, each transaction of the sequence of transactions is supplied to the RNN, one at a time, where the state value of the RNN is updated during each iteration. The resulting computed confidence or likelihood that the latest transaction is fraudulent is therefore computed based on the state value computed based on all of the previous transactions in the sequence.

To illustrate the operation of the recurrent neural network, FIG. 1A further shows an unfolded computation 120 using the neural network 111 on each input data sample of a sequence of data samples. Considering a sequence of inputs culminating in a current input xₜ at timestamp t: [. . . , xₜ₋₃, xₜ₋₁, xₜ]. Considering the finite case, the sequence may be considered to have N+1 values and therefore be represented as [x_{t-N . . .} , Xₜ₋₃, Xₜ₋₂, Xₜ₋₁, Xₜ], where N is a positive integer. When using an RNN to compute an inference regarding the current input data sample xₜ, the sequence of N previous data samples [x_{t-N} . . . , xₜ₋₃, xₜ₋₂, xₜ₋₁] is presented, one at a time, to the neural network 111, which results in computing an output oₜ for that data sample, and which computes an updated internal state value hₜ for that current data sample, also taking a previous internal state value hₜ₋₁ scaled by weights v as an input (as indicated by the looping connection labeled with its weights v). The updated internal state value hₜ is then scaled by weights v and presented as an input for the next run of the RNN for the next data sample (e.g., xₜ₊₁) in the sequence. The input weights u, the output weights w, the internal state weights v, and the internal weights of the neural network 111 are computed during training of the sequence model 110 and remain fixed in deployment.

Considering data sample xₜ₋₂, at 122 the features extracted from this data sample are scaled by input weights u and supplied to the neural network 111 along with the internal state value hₜ₋₃ from the previous run of the neural network at 121, scaled by weights v. The resulting activations of the neural network are scaled by output weights w to compute a corresponding output oₜ₋₂. At 123, the next data sample in the sequence xₜ₋₁ is supplied to the neural network 111 to compute the updated internal state value hₜ₋₁ based on the previous internal state value hₜ₋₂ and the input data sample Xₜ₋₁. The prediction oₜ for the current data sample xₜ can then be computed at 125 by the neural network 111 based on the current data sample xₜ and the previous internal state value hₜ₋₁ (through the dashed line shown in FIG. 1A). The output may then be provided to a consuming service The outputs from the previous data samples in the sequence, such as oₜ₋₂ and oₜ₋₁ may be discarded or ignored in the process of computing the output ot for the current input xₜ.

Storing all the data samples x of the various sequences (e.g., in the case of credit card fraud detection, storing and retrieving the sequences of transactions for each credit card) may consume a significant amount of space in a database of the system supporting the sequence model 110 in computing inferences based on the sequence. In addition, running the neural network numerous times for each data sample in the sequence to compute an input internal state value hₜ₋₁ for performing an inference on current data sample xₜ can consume significant computing resources.

For example, a next data sample xₜ₊₁ in the sequence may arrive at some later time (e.g., hours, days, or weeks later, when the credit card is next used). In such circumstances, the previously computed internal state value hₜ may have previously been discarded (e.g., because the computer system executing the sequence model 110 was used in the interim to compute an inference on a different sequence or execute a different sequence model). Accordingly, to compute the inference for this next data sample Xₜ₊₁, the history of prior data samples (e.g., prior transactions, such as [x_{t-N} . . . , xₜ₋₃, xₜ₋₁, xₜ]) may be retrieved from a data store (e.g., a database of transactions) and supplied, one at a time, to the sequence model 110 executed on the one or more processing devices to compute the internal state value hₜ that is then supplied as input, along with the next data sample xₜ₊₁, to compute an output oₜ₊₁ inference or prediction for that next data sample xₜ₊₁.

FIG. 1B is a graphical depiction of multiple dimensions of sequence data using a credit card transaction as an example of a current data sample 171 and where a credit card number and a merchant identifier (having a value of 10001 in the example of FIG. 1B) are used as different dimensions, according to one embodiment of the present disclosure. The same underlying collection of data samples may be used along different dimensions to perform different types of inferences or computations.

The example discussed above related to detecting credit card fraud associated with a single credit card number based on a sequence of prior transactions associated with that credit card number (e.g., to determine whether the current transaction was attempted by an unauthorized third party using a stolen credit card number). In the example shown in FIG. 1B, a horizontal direction shows a first sequence of transactions 170 along the credit card dimension, where each transaction has the same value for the credit card number (having a value of 4242 4242 4242 4242 in the example of FIG. 1B) but other transactions (e.g., transactions 172 and 173) may have different merchant IDs and different transaction amounts.

Another type of inference based on the same underlying transaction data may relate to detecting card testing fraud, where a party in possession of many credit card numbers attempts a charge on each credit card number to determine whether that it is still valid. In this case, these charges may be attempted against a single merchant (e.g., a complicit merchant account), in which case all transactions associated with a given merchant identifier (or merchant id) would be included in the sequence of data samples that are supplied to a trained sequence machine learning model. FIG. 1B shows a second sequence of transactions 180 along this second dimension of merchant id, where each previous transaction (data samples 182, 183, 184, and 185 shown in FIG. 1B) in the second sequence 180 has the same merchant id value (e.g., 10001 in FIG. 1B), and where the credit card numbers (CCN) and amounts may be the same or different between transactions. (This trained sequence machine learning model would be different from the sequence model trained to detect whether a given transaction may be fraudulent based on a sequence of prior transactions associated with the same credit card number, as different features of the transaction may be relevant.) In addition, there may be overlaps in the transactions or data samples appearing in different sequences of previous samples associated with a given current data sample. FIG. 1B shows a transaction 172 in the first sequence 170 that also appears as transaction 185 in the second sequence 180 along a different dimension.

Still another sequence model to detect some other type of fraud may depend on combinations of merchants and credit card numbers (e.g., a merchant id and credit card number pair). Examples of dimensions in the space of credit card transactions include, in addition to merchant id and credit card number, internet protocol (IP) address associated with the transaction and email address associated with the transaction, and combinations of these dimensions (e.g., a merchant id and IP address pair). Some of these dimensions are associated with sequences are large and fast moving (e.g., a large volume merchant may have many transactions per second associated with its merchant id) while other dimensions may have smaller and slower moving sequences (e.g., all transactions associated with a single credit card number).

Another example of dimensions of sequences are a consumer identifier and a product identifier for consumer purchases on a retail merchant. A sequence of prior purchases associated with a particular consumer (along the dimension of consumer identifier) may be used to predict a next product (a product identifier) that the consumer will be interested in purchasing. As another example, taking the sequence along the dimension of a single product identifier, identifying a sequence of other customers who have purchased a particular product may identify another customer who may be interested in this product.

Accordingly, aspects of embodiments of the present disclosure relate to storing the internal state value of a machine learning model for a given sequence in a sequence model state data store 150 and retrieving the state value from the sequence model state data store 150 for that sequence when the next data sample is to be processed. Aspects embodiments of the present disclosure improve the processing speed of executing recurrent neural network models because the prior data samples of sequences do not need to be evaluated (e.g., run through the neural network) to compute the state value prior to performing inference on the current data sample. In addition, in some circumstances, embodiments of the present disclosure reduce the amount of data that needs to be stored to support performing inferences using one or more sequence machine learning models because the stored state values, and not the full sets of transactions, are sufficient to perform inference. Storing and retrieving the internal state values of the recurrent neural networks also reduces the bandwidth consumed when loading data into the sequence model to be processed (e.g., loading only the state value instead of features extracted from each data sample of a sequence of data samples stored in a data store such as a feature store).

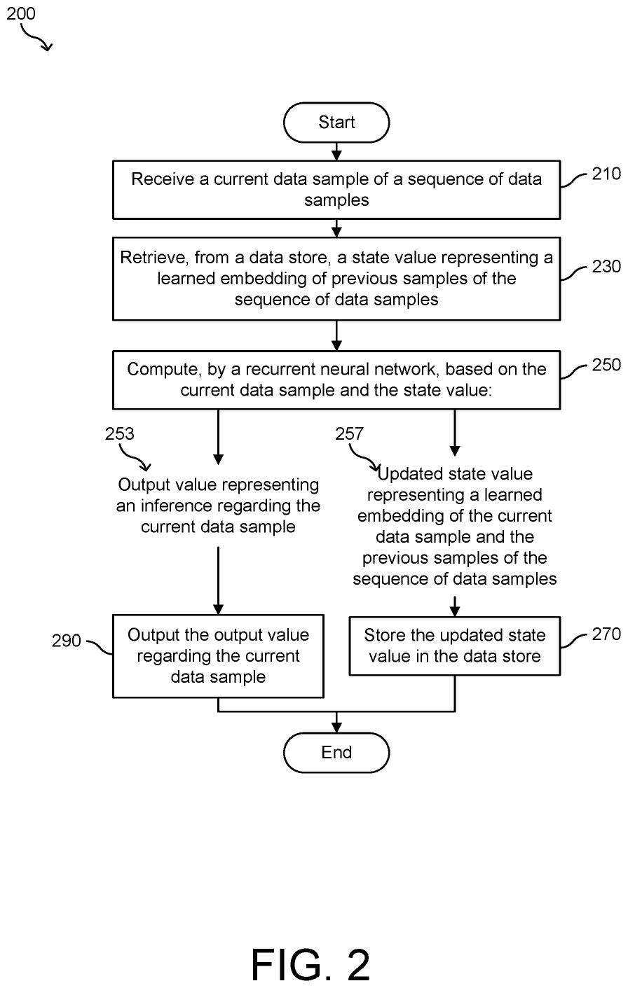

FIG. 2 is a flowchart of a method 200 for using a sequence model state data store with a sequence machine learning model, according to one embodiment of the present disclosure. In various embodiments, the method 200 is implemented on one or more processing devices or processing circuits of a computer system, such as computer systems described in more detail below in reference to FIGS. 5, 6, and 7. In more detail, the method includes executing a recurrent neural network or other sequence machine learning model such as the sequence machine learning model 110 described above and shown in FIG. 1A.

At 210, the computer system receives a current data sample of a sequence of data samples. For example, in the case where the data samples are credit card transactions, a current data sample may be a single credit card transaction, which may be associated with a credit card number (and other information such as a card security code (CSC), card validation code (CVC), or card verification value (CVV), billing postal code, phone number, email address, and the like), a merchant identifier, a merchant category code, a transaction amount, a transaction description, a timestamp, and the like. Referring to FIG. 1A, the current data sample may be represented by the next data sample xₜ₊₁.

As noted above, the sequence of data samples may correspond to a particular dimension of a set of sequence data. One example of a dimension in the above context of credit card transactions is credit card numbers and a sequence along this dimension would be a sequence of credit card transactions associated with the credit card number present in the current data sample. Another example of a dimension in the above context is merchant identifier, and a sequence along this dimension would be a sequence of credit card transactions associated with the merchant identifier present in the current data sample.

At 230, the computer system retrieves, from a data store (e.g., the sequence model state data store 150), a state value representing a learned embedding of previous samples of the sequence of data samples. The value may be retrieved based on key specified by a value of a dimension of the data and/or a specified sequence machine learning model. In the example of detecting fraud based on a confidence or likelihood that a current credit card transaction is fraudulent based on the sequence of previous transactions leading up to the current credit card transaction, the specified dimension would be a credit card number and the value of the specified dimension would be the specific credit card number in the transaction. As such, the credit card number identified in the current data sample and the specified sequence machine learning model (e.g., the machine learning model for evaluating the confidence or likelihood of fraud) are used to lookup the saved state value from the data store (e.g., the data store may be implemented as a key-value store or key-value database such as Redis®, RocksDB, Memcached, or the like, where the credit card number and an identifier associated with the specified machine learning model are used as the key).

The state value corresponding to the learned embeddings of the previous samples of the sequence of data samples ([x_{t-N} . . . , xₜ₋₃, xₜ]) is shown in FIG. 1A as hₜ, which was previously saved in the sequence model state data store 150 after computing the output value oₜ for the input data sample of xₜ.

At 250, the computer system computes, using the recurrent neural network 111 (or other sequence machine learning model) based on the current data sample (xₜ₊₁) and the state value (hₜ) retrieved from the sequence model state data store 150, an output value 253 (oₜ₊₁ as shown in FIG. 1A) representing an inference regarding the current data sample (xₜ₊₁ as shown in FIG. 1A) and an updated state value 257 (hₜ₊₁ as shown in FIG. 1A) representing a learned embedding of the sequence including the current data sample and the previous samples of the sequence of data samples ([x_{t-N} . . . , xₜ₋₃, xₜ₋₁, xₜ, xₜ₊₁]). In some embodiments, the updated state value 257 replaces the previous state value stored in the sequence model data store 150 in association with the given key (e.g., the pair of the value of the specified dimension and the sequence model identifier). In some embodiments, a history of state values (e.g., a list of state values) is stored in the key-value store, where the most recently inserted value is retrieved by default.

At 270, the computer system stores the updated state value (hₜ₊₁ as shown in FIG. 1A) in the sequence model state data store 150 and at 290, the computer system outputs the output value (oₜ₊₁ as shown in FIG. 1A) regarding the current data sample (xₜ₊₁).

Accordingly, the method described above with respect to FIG. 1A and FIG. 2 reduces the computational and data transfer overheads associated with computing an inference for a current data sample (xₜ₊₁). Data transfer overhead (and latency caused by this data transfer) is reduced from transferring features associated with each of the data samples of the sequence leading up to the current data sample ([x_{t-N} . . . , xₜ₋₃, xₜ₋₁, xₜ]) to the computer system implementing the sequence machine learning model to transferring the stored state value ht corresponding to a learned embedding of the sequence [x_{t-N} . . . , xₜ₋₃, xₜ₋₁, xₜ]. Computational overhead is reduced from performing, for example, N+1 runs of the sequence model (e.g., the recurrent neural network 111) for each data sample in the sequence that includes current data sample ([x_{t-N} . . . , xₜ₋₃, xₜ, xₜ₊₁]) to performing a single run of the sequence model just for the current data sample (Xₜ₊₁).

As discussed above, the data samples may extend along multiple different dimensions of sequences. In the example above, the current data sample (xₜ₊₁) is a credit card transaction, and the sequence model related to computing an inference as to the likelihood that this current data sample was fraudulent based on prior transactions using the same credit card number (e.g., using credit card number as the dimension). However, the current data sample may also be relevant to other sequence models trained to compute different inferences along different dimensions (e.g., detect credit card testing fraud along a merchant identifier dimension) or along the same dimension (e.g., analyze spending habits to generate targeted advertising to the holder of the credit card number).

Accordingly, some aspects of embodiments of the present disclosure relate to applying the method described above with respect to FIG. 2 to multiple different sequence models operating along the same dimensions or different dimensions.

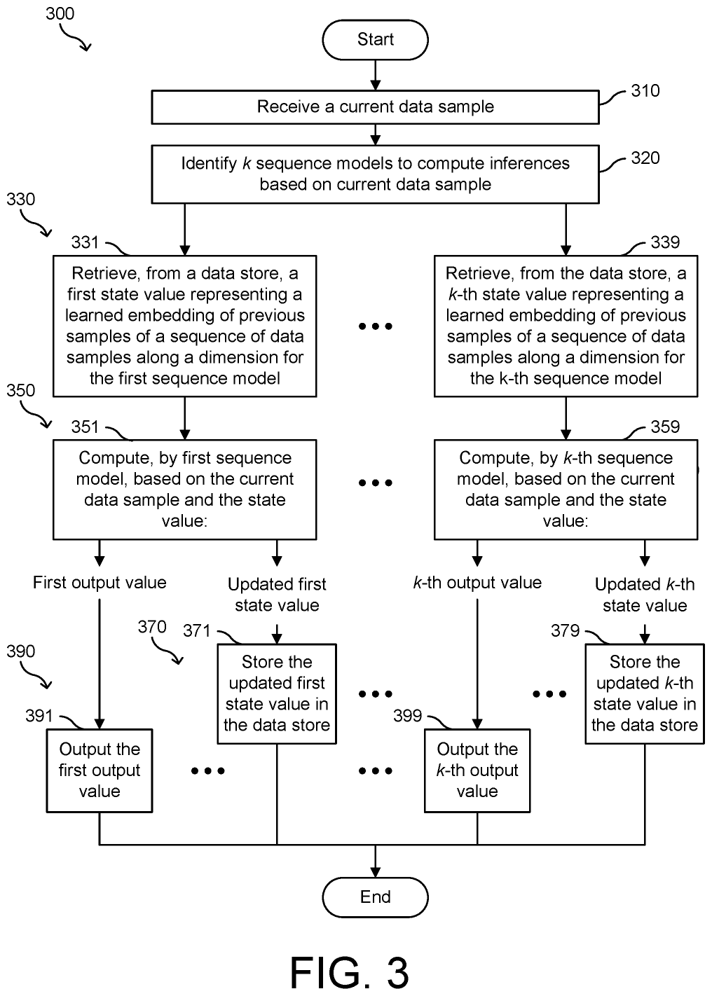

FIG. 3 is a flowchart of a method 300 for using a sequence model state data store with a sequence machine learning model, according to one embodiment of the present disclosure. The method 300 shown in FIG. 3 may be implemented by one or more processing devices or processing circuits of a computer system, such as computer systems described in more detail below in reference to FIGS. 5, 6, and 7. In a manner similar to the method 200 of FIG. 2, at 310 the computer system receives a current data sample (e.g., xₜ). At 320, the computer system identifies a plurality of sequence models (e.g., k different sequence models) to compute inferences or predictions using this current data sample xₜ. These k different sequence models may be associated with different dimensions of the data sample (e.g., a credit card number dimension, a merchant id dimension, an email address dimension, and the like) and some sequence models may operate along a same dimension (e.g., multiple different sequence models may operate along the credit card number dimension to compute different types of inferences, such as fraud detection versus advertising targeting based on purchase history).

At 330, the computer system performs operations like those described above with respect to FIG. 2 for each of the k different sequence models. For example, at 331, the computer system retrieves, from a data store (e.g., the sequence model state data store 150), a first state value representing a learned embedding of previous samples of the sequence of data samples for the first sequence model (from among the k different sequence models). Similarly, at 339, the computer system retrieves, from the data store (e.g., the same sequence model state data store 150), a k-th state value representing a learned embedding of previous samples of the sequence of data samples for the k-th sequence model (from among the k different sequence models).

As noted above, during the training process for each sequence model, the sequence model learns or trains weights that produce an embedding of the input data (the features of the current data sample and the previous state value) that is tailored for the particular inferences or predictions that are to be made by that sequence model. As such, each sequence model has a different embedding and therefore stores a different state value in the sequence model state data stare 150 for its sequence along a given dimension, even if the dimensions are the same (e.g., even if two different sequence models operate along the credit card number dimension). The stored state value of a sequence model is also specific to the particular value of the dimension along which the sequence extends. For example, a fraud detection sequence model trained to detect fraud for a given credit card number given previous transactions on that credit card number stores a separate state value for each credit card number whose transactions are observed in the system (e.g., credit card number 4242 4242 4242 4242 and credit card number 3782 822463 10005 are associated with different state values).

At 350, the computer system computes k output values and k updated state values for the k different sequence models identified at 320. For example, at 351 the computer system computes a first output value and a first updated state value using the first sequence model based on the current data sample and the first state value that was retrieved from the data store. Similarly, at 359 the computer system computes a k-th output value and a k-th updated state value using the k-th sequence model based on the current data sample and the k-th state value that was retrieved from the data store.

At 370, the computer system stores the k updated state values in the sequence model state data store, including storing the updated first state value at 371 and the updated k-th state value at 379.

At 390, the computer system outputs the k output values, including the first output value at 391 and the k-th output value at 399.

These k different computations for the k different sequence models may be performed concurrently, sequentially, or in combinations thereof. For example, k different tasks may be added to a task queue, a pool of worker threads running on the computer system retrieve the tasks from the task queue and perform the corresponding operations, and where these worker threads may run on different processing devices or processing circuits (e.g., different processor cores in one or more different computers) of the computer system.

Some aspects of embodiments of the present disclosure further relate to computing a new state value when a new sequence model is deployed. As noted above, the stored state values correspond to learned embeddings of sequences of data samples, where the learned embeddings are computed based on the trained parameters of a corresponding sequence model. When the sequence model is updated (e.g., retrained or where there is a change in architecture such as a change in the number of hidden layers or number of neurons in the hidden layers), then the state values stored by the previous version of the sequence model will not be compatible with the updated version of the sequence model.

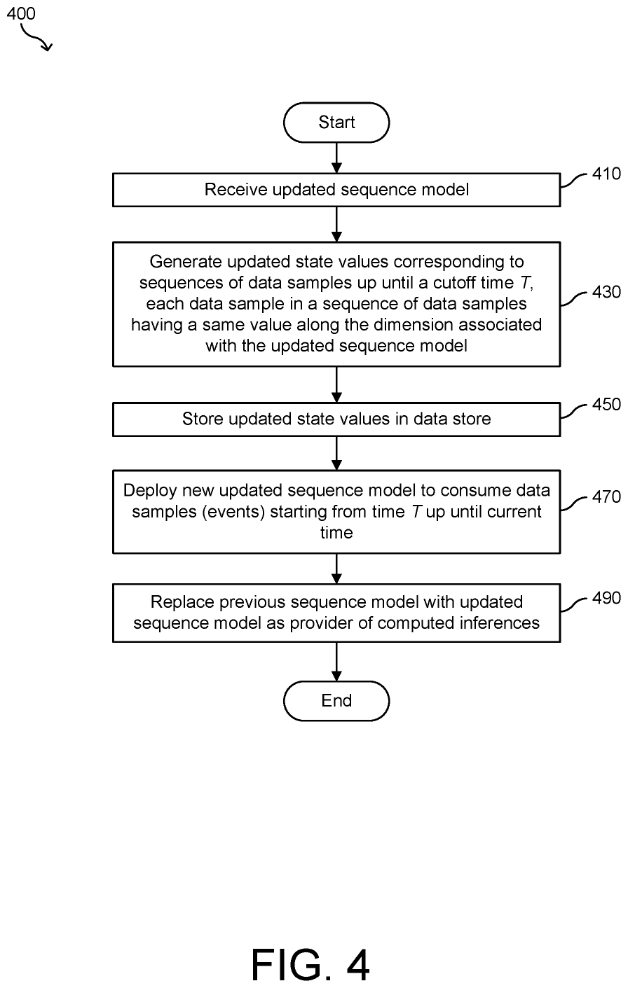

FIG. 4 is a flowchart of a method 400 for updating a sequence model data store based on an updated sequence model, according to one embodiment of the present disclosure. The method 400 shown in FIG. 4 may be implemented by one or more processing devices or processing circuits of a computer system, such as computer systems described in more detail below in reference to FIGS. 5, 6, and 7.

At 410, the computer system receives an updated trained sequence model, which will functionally replace a previous sequence model for computing inferences (e.g., computing an inference regarding confidence or likelihood that a given transaction is fraudulent based on a sequence of prior transactions associated with the credit card number associated with that transaction). At 430, the computer system pre-computes state values using the updated sequence model by replaying previous data samples (e.g., events or transactions) of each sequence up until a cutoff time T (e.g., all data samples having timestamps smaller than time T) such that the new state values correspond to the learned embeddings of the updated sequence model. For example, in an updated sequence model operating on a credit card number dimension, a separate new state value would be computed for each credit card number seen in the historic or previous transactions, as each credit card number corresponds to a separate sequence. At 450, the computer system stores the updated state values (the state values corresponding to the updated sequence model) in the sequence model data store 150.

At 470, the computer system deploys the updated sequence model such that the updated sequence model consumes current and recent transactions (e.g., starting from time T) using the methods described above (e.g., methods 200 and 300 described above with respect to FIGS. 2 and 3) to update the state values in the data store to catch up with the current data samples being processed.

At 490, once the updated sequence model has caught up to current conditions, the consumers of the inferences (e.g., end user products for analyzing and detecting fraud in credit card transactions or services for generating targeted recommendations or advertising) are updated such that the updated sequence model provides the computed inferences instead of the previous sequence model. The previous sequence model can then be removed or disabled.

Accordingly, aspects of embodiments of the present disclosure relate to systems and methods for improving the performance of sequence machine learning models deployed in an environment by storing the internal state values (or internal states) representing learned embeddings of sequences of prior data samples such that computing an inference on a current data sample of the sequence can be performed by loading the stored state value and processing the current data sample. This approach avoids the re-processing of the previous data samples of the sequence through the sequence machine learning model and reduces the data transfer associated with loading the previous data samples into the machine learning model (e.g., implemented using a CPU, a GPU, neural accelerator, or the like), thereby reducing the latency associated with performing inferences using sequential machine learning models.

With reference to FIG. 5, an example embodiment of a high-level SaaS network architecture 500 is shown. A networked system 516 provides server-side functionality via a network 510 (e.g., the Internet or a WAN) to a client device 508. A web client 502 and a programmatic client, in the example form of a client application 504 (e.g., client software for receiving alerts generated based on the outputs of sequence models, such as alerts regarding suspected credit card fraud), are hosted and execute on the client device 508. The networked system 516 includes one or more servers 522 (e.g., servers hosting services exposing remote procedure call APIs), which hosts a processing system 506 (such as the processing system described above according to various embodiments of the present disclosure supporting service for automatically processing accounting data) that provides a number of functions and services via a service oriented architecture (SOA) and that exposes services to the client application 504 that accesses the networked system 516 where the services may correspond to particular workflows. The client application 504 also provides a number of interfaces described herein, which can present an output in accordance with the methods described herein to a user of the client device 508.

The client device 508 enables a user to access and interact with the networked system 516 and, ultimately, the processing system 506. For instance, the user provides input (e.g., touch screen input or alphanumeric input) to the client device 508, and the input is communicated to the networked system 516 via the network 510. In this instance, the networked system 516, in response to receiving the input from the user, communicates information back to the client device 508 via the network 510 to be presented to the user.

An API server 518 and a web server 520 are coupled, and provide programmatic and web interfaces respectively, to the servers 522. For example, the API server 518 and the web server 520 may produce messages (e.g., RPC calls) in response to inputs received via the network, where the messages are supplied as input messages to workflows orchestrated by the processing system 506. The API server 518 and the web server 520 may also receive return values (return messages) from the processing system 506 and return results to calling parties (e.g., web clients 502 and client applications 504 running on client devices 508 and third-party applications 514) via the network 510. The servers 522 host the processing system 506, which includes components or applications in accordance with embodiments of the present disclosure as described above. The servers 522 are, in turn, shown to be coupled to one or more database servers 524 that facilitate access to information storage repositories (e.g., databases 526). In an example embodiment, the databases 526 includes storage devices that store information accessed and generated by the processing system 506, such as the persistent store 280 of FIG. 2 and the persistent store 580 of FIG. 5 and other databases such as databases storing information associated with transactions processed by a business.

Additionally, a third-party application 514, executing on one or more third-party servers 521, is shown as having programmatic access to the networked system 516 via the programmatic interface provided by the API server 518. For example, the third-party application 514, using information retrieved from the networked system 516, may support one or more features or functions on a website hosted by a third-party. For example, the third-party application 514 may serve as a data source for retrieving, for example, information regarding data samples of sequences of data samples.

Turning now specifically to the applications hosted by the client device 508, the web client 502 may access the various systems (e.g., the processing system 506) via the web interface supported by the web server 520. Similarly, the client application 504 (e.g., an “app” such as a payment processor app) may access the various services and functions provided by the processing system 506 via the programmatic interface provided by the API server 518. The client application 504 may be, for example, an “app” executing on the client device 508, such as an iOS or Android OS application to enable a user to access and input data on the networked system 516 in an offline manner and to perform batch-mode communications between the client application 504 and the networked system 516.

Further, while the network architecture 500 shown in FIG. 5 employs a client-server architecture, the present disclosure is not limited to such an architecture, and could equally well find application in a distributed, or peer-to-peer, architecture system, for example.

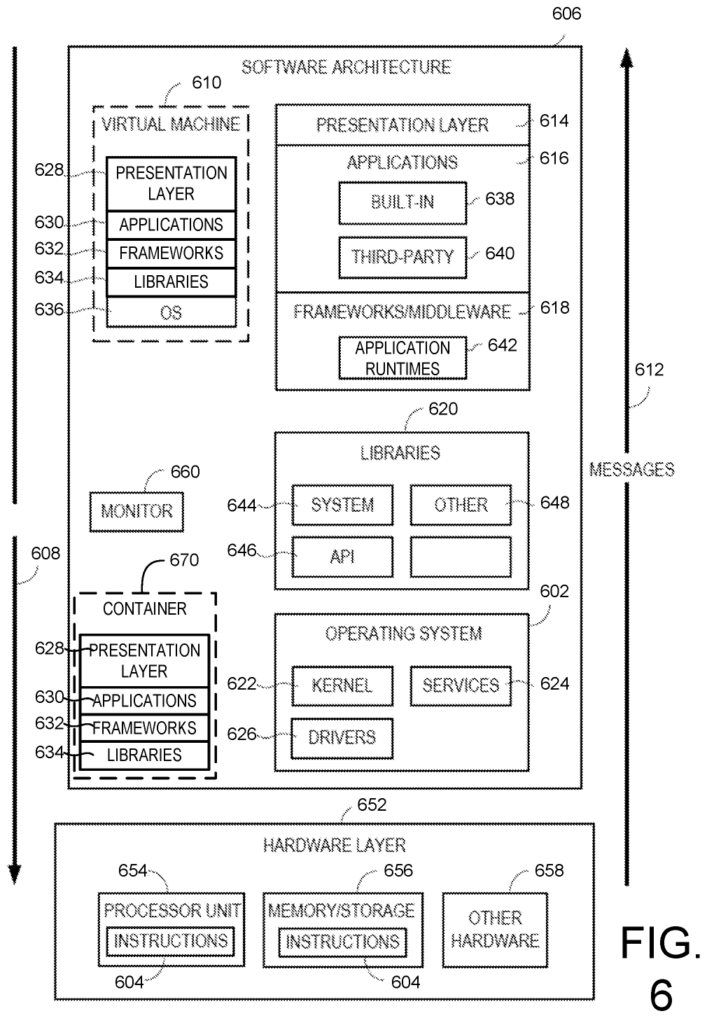

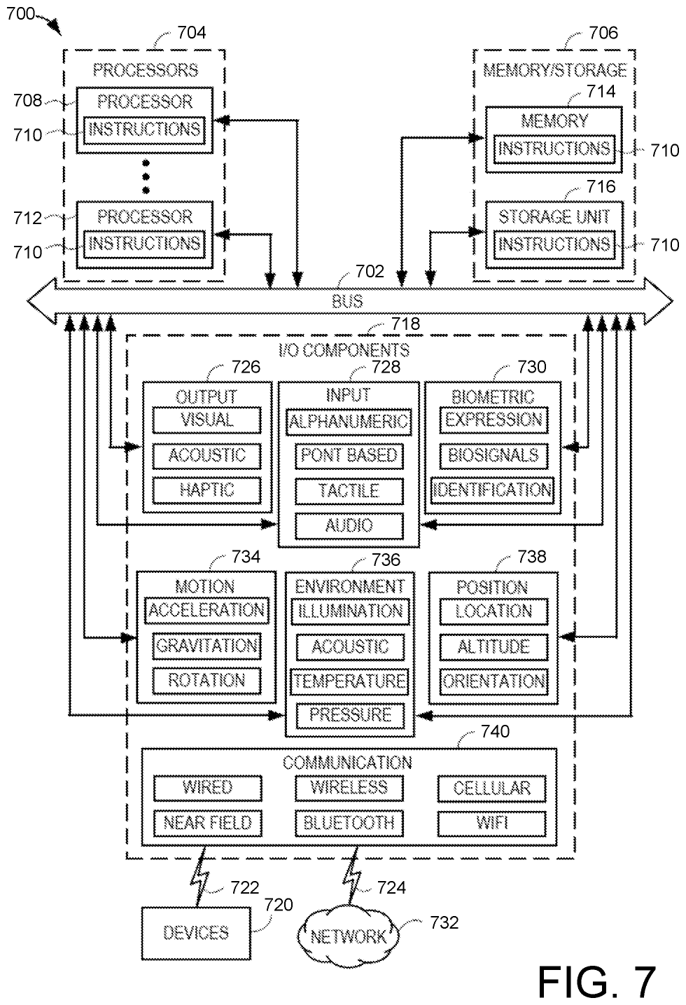

FIG. 6 is a block diagram illustrating an example software architecture 606, which may be used in conjunction with various hardware architectures herein described. FIG. 6 is a non-limiting example of a software architecture 606, and it will be appreciated that many other architectures may be implemented to facilitate the functionality described herein. The software architecture 606 may execute on hardware such as a machine 700 of FIG. 7 that includes, among other things, processors 704, memory/storage 706, and input/output (I/O) components 718. A representative hardware layer 652 is illustrated and can represent, for example, the machine 700 of FIG. 7. The representative hardware layer 652 includes a processor 654 having associated executable instructions 604. The executable instructions 604 represent the executable instructions of the software architecture 606, including implementation of the methods, components, and so forth described herein. The hardware layer 652 also includes non-transitory memory and/or storage modules as memory/storage 656, which also have the executable instructions 604. The hardware layer 652 may also include other hardware 658.

In the example architecture of FIG. 6, the software architecture 606 may be conceptualized as a stack of layers where each layer provides particular functionality. For example, the software architecture 606 may include layers such as an operating system 602, libraries 620, frameworks/middleware 618, applications 616 (such as the services of the processing system), and a presentation layer 614. Operationally, the applications 616 and/or other components within the layers may invoke API calls 608 through the software stack and receive a response as messages 612 in response to the API calls 608. The layers illustrated are representative in nature, and not all software architectures have all layers. For example, some mobile or special-purpose operating systems may not provide a frameworks/middleware 618, while others may provide such a layer. Other software architectures may include additional or different layers.

The operating system 602 may manage hardware resources and provide common services. The operating system 602 may include, for example, a kernel 622, services 624, and drivers 626. The kernel 622 may act as an abstraction layer between the hardware and the other software layers. For example, the kernel 622 may be responsible for memory management, processor management (e.g., scheduling), component management, networking, security settings, and so on. The services 624 may provide other common services for the other software layers. The drivers 626 are responsible for controlling or interfacing with the underlying hardware. For instance, the drivers 626 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 620 provide a common infrastructure that is used by the applications 616 and/or other components and/or layers. The libraries 620 provide functionality that allows other software components to perform tasks in an easier fashion than by interfacing directly with the underlying operating system 602 functionality (e.g., kernel 622, services 624, and/or drivers 626). The libraries 620 may include system libraries 644 (e.g., C standard library) that may provide functions such as memory allocation functions, string manipulation functions, mathematical functions, and the like. In addition, the libraries 620 may include API libraries 646 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), and the like. The libraries 620 may also include a wide variety of other libraries 648 to provide many other APIs to the applications 616 and other software components/modules.

The frameworks/middleware 618 provide a higher-level common infrastructure that may be used by the applications 616 and/or other software components/modules. For example, the frameworks/middleware 618 may provide high-level resource management functions, web application frameworks, application runtimes 642 (e.g., a Java virtual machine or JVM), and so forth. The frameworks/middleware 618 may provide a broad spectrum of other APIs that may be utilized by the applications 616 and/or other software components/modules, some of which may be specific to a particular operating system or platform.

The applications 616 include built-in applications 638 and/or third-party applications 640. The applications 616 may use built-in operating system functions (e.g., kernel 622, services 624, and/or drivers 626), libraries 620, and frameworks/middleware 618 to create user interfaces to interact with users of the system. Alternatively, or additionally, in some systems, interactions with a user may occur through a presentation layer, such as the presentation layer 614. In these systems, the application/component “logic” can be separated from the aspects of the application/component that interact with a user.

Some software architectures use virtual machines. In the example of FIG. 6, this is illustrated by a virtual machine 610. The virtual machine 610 creates a software environment where applications/components can execute as if they were executing on a hardware machine (such as the machine 700 of FIG. 7, for example). The virtual machine 610 is hosted by a host operating system (e.g., the operating system 602 in FIG. 6) and typically, although not always, has a virtual machine monitor 660 (or hypervisor), which manages the operation of the virtual machine 610 as well as the interface with the host operating system (e.g., the operating system 602). A software architecture executes within the virtual machine 610 such as an operating system (OS) 636, libraries 634, frameworks 632, applications 630, and/or a presentation layer 628. These layers of software architecture executing within the virtual machine 610 can be the same as corresponding layers previously described or may be different.

Some software architectures use containers 670 or containerization to isolate applications. The phrase “container image” refers to a software package (e.g., a static image) that includes configuration information for deploying an application, along with dependencies such as software components, frameworks, or libraries that are required for deploying and executing the application. As discussed herein, the term “container” refers to an instance of a container image, and an application executes within an execution environment provided by the container. Further, multiple instances of an application can be deployed from the same container image (e.g., where each application instance executes within its own container). Additionally, as referred to herein, the term “pod” refers to a set of containers that accesses shared resources (e.g., network, storage), and one or more pods can be executed by a given computing node. A container 670 is similar to a virtual machine in that it includes a software architecture including libraries 634, frameworks 632, applications 630, and/or a presentation layer 628, but omits an operating system and, instead, communicates with the underlying host operating system 602.

FIG. 7 is a block diagram illustrating components of a machine 700, according to some example embodiments, able to read instructions from a non-transitory machine-readable medium (e.g., a computer-readable storage medium) and perform any one or more of the methodologies discussed herein. Specifically, FIG. 7 shows a diagrammatic representation of the machine 700 in the example form of a computer system, within which instructions 710 (e.g., software, a program, an application, an applet, an app, or other executable code) for causing the machine 700 to perform any one or more of the methodologies discussed herein may be executed. As such, the instructions 710 may be used to implement modules or components described herein. The instructions 710 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may include, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 710, sequentially or in parallel or concurrently, that specify actions to be taken by the machine 700. Further, while only a single machine 700 is illustrated, the term “machine” or “processing circuit” shall also be taken to include a collection of machines that individually or jointly execute the instructions 710 to perform any one or more of the methodologies discussed herein.

The machine 700 may include processors 704 (including processors 708 and 712), memory/storage 706, and I/O components 718, which may be configured to communicate with each other such as via a bus 702. The memory/storage 706 may include a memory 714, such as a main memory, or other memory storage, and a storage unit 716, both accessible to the processors 704 such as via the bus 702. The storage unit 716 and memory 714 store the instructions 710 embodying any one or more of the methodologies or functions described herein. The instructions 710 may also reside, completely or partially, within the memory 714, within the storage unit 716, within at least one of the processors 704 (e.g., within the processor's cache memory), or any suitable combination thereof, during execution thereof by the machine 700. Accordingly, the memory 714, the storage unit 716, and the memory of the processors 704 are examples of machine-readable media.

The I/O components 718 may include a wide variety of components to receive input, provide output, produce output, transmit information, exchange information, capture measurements, and so on. The specific I/O components 718 that are included in a particular machine will depend on the type of machine. For example, portable machines such as mobile phones may include a touch input device or other such input mechanisms, while a headless server machine will likely not include such a touch input device. It will be appreciated that the I/O components 718 may include many other components that are not shown in FIG. 7. The I/O components 718 are grouped according to functionality merely for simplifying the following discussion, and the grouping is in no way limiting. In various example embodiments, the I/O components 718 may include output components 726 and input components 728. The output components 726 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 728 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 718 may include biometric components 730, motion components 734, environment components 736, or position components 738, among a wide array of other components. For example, the biometric components 730 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 734 may include acceleration sensor components (e.g., accelerometer), gravitation sensor components, rotation sensor components (e.g., gyroscope), and so forth. The environment components 736 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas sensors to detect concentrations of hazardous gases for safety or to measure pollutants in the atmosphere), or other components that may provide indications, measurements, or signals corresponding to a surrounding physical environment. The position components 438 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 718 may include communication components 740 operable to couple the machine 700 to a network 732 or devices 720 via a coupling 724 and a coupling 722, respectively. For example, the communication components 740 may include a network interface component or other suitable device to interface with the network 732. In further examples, the communication components 740 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 720 may be another machine or any of a wide variety of peripheral devices (e.g., a peripheral device coupled via a USB).

Moreover, the communication components 740 may detect identifiers or include components operable to detect identifiers. For example, the communication components 740 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 740, such as location via Internet Protocol (IP) geo-location, location via Wi-Fi® signal triangulation, location via detecting an NFC beacon signal that may indicate a particular location, and so forth.

It should be understood that the sequence of steps of the processes described herein in regard to various methods and with respect various flowcharts is not fixed, but can be modified, changed in order, performed differently, performed sequentially, concurrently, or simultaneously, or altered into any desired order consistent with dependencies between steps of the processes, as recognized by a person of skill in the art. Further, as used herein and in the claims, the phrase “at least one of element A, element B, or element C” is intended to convey any of: element A, element B, element C, elements A and B, elements A and C, elements B and C, and elements A, B, and C.

According to one embodiment of the present disclosure, a method for computing a prediction using a machine learning model includes: receiving a current data sample of a sequence of data samples; retrieving, from a data store, a state value representing a learned embedding of previous samples of the sequence of data samples; computing, by a recurrent neural network, based on the current data sample and the state value: an output value representing an inference regarding the current data sample; and an updated state value representing a learned embedding of the current data sample and the previous samples of the sequence of data samples; storing the updated state value in the data store; and outputting the output value regarding the current data sample.

The recurrent neural network may be trained to compute state values representing learned embeddings of sequences of data samples and output values based on training sequences of training data samples and corresponding labels, and the state value may include a vector of numerical values in a multi-dimensional latent space.

The data samples may include a plurality of dimensions, and the data samples of the sequence of data samples and the current data sample may have a same value in a first dimension.

The method may further include: determining a second sequence of second data samples having a same value as the current data sample in a second dimension of the plurality of dimensions; retrieving, from the data store, a second state value representing a learned embedding of previous second data samples of the second sequence of second data samples; computing, by a second recurrent neural network, based on the current data sample and the second state value: a second output value representing a second inference regarding the current data sample; and a second updated state value representing a learned embedding of the current data sample and the previous second data samples of the second sequence of second data samples; storing the second updated state value in the data store; and outputting the second output value regarding the current data sample.

The data samples may correspond to transactions, the dimensions may include: a merchant identifier; and a credit card number, and the inference may correspond to a likelihood that the current data sample is a fraudulent transaction in the sequence of data samples having a same merchant identifier.

The second inference may correspond to a likelihood that the current data sample is a second fraudulent transaction in the second sequence of second data samples having a same credit card number.

The data samples may correspond to product selections, the dimensions may include: a consumer identifier; and a product identifier, and the inference may correspond to a likelihood that a consumer will select a product corresponding to the current data sample.

According to one embodiment of the present disclosure, a system includes: a processor; and memory storing instructions that, when executed, cause the processor to: receive an updated sequence model associated with a dimension; generate a plurality of updated state values corresponding to a plurality of sequences of data samples up until a cutoff time, each data sample in a sequence of data samples having a same value along the dimension associated with the updated sequence model; store the updated state values in a sequence model state data store; deploy the updated sequence model to consume data samples from the cutoff time and to update the updated state values in the sequence model state data store; and replace a previous sequence model with the updated sequence model as a provider of computed inferences.

The memory may further store instructions that, when executed, cause the processor to: receive a current data sample of a sequence of data samples; retrieve, from the sequence model state data store, a state value representing a learned embedding of previous samples of the sequence of data samples computed by the updated sequence model; compute, by the updated sequence model, based on the current data sample and the state value: an output value representing an inference regarding the current data sample; and an updated state value representing a learned embedding of the current data sample and the previous samples of the sequence of data samples; store the updated state value in the sequence model state data store; and output the output value regarding the current data sample.

The updated sequence model may be trained to compute state values representing learned embeddings of sequences of data samples and output values based on training sequences of training data samples and corresponding labels, and a state value of the state values may include a vector of numerical values in a multi-dimensional latent space.

The previous sequence model may include a previous recurrent neural network and the updated sequence model includes an updated recurrent neural network.

According to one embodiment of the present disclosure, a non-transitory computer-readable medium storing instructions that, when executed, cause a computer system including a processing circuit to: receive a current data sample of a sequence of data samples; retrieve, from a data store, a state value representing a learned embedding of previous samples of the sequence of data samples; compute, by a sequence machine learning model, based on the current data sample and the state value: an output value representing an inference regarding the current data sample; and an updated state value representing a learned embedding of the current data sample and the previous samples of the sequence of data samples; store the updated state value in the data store; and output the output value regarding the current data sample.

The sequence machine learning model may be trained to compute state values representing learned embeddings of sequences of data samples and output values based on training sequences of training data samples and corresponding labels, and the state value may include a vector of numerical values in a multi-dimensional latent space.

The data samples may include a plurality of dimensions, and the data samples of the sequence of data samples and the current data sample may have a same value in a first dimension.

The non-transitory computer-readable medium of claim may further store instructions that, when executed, cause the computer system to: determine a second sequence of second data samples having a same value as the current data sample in a second dimension of the plurality of dimensions; retrieve, from the data store, a second state value representing a learned embedding of previous second data samples of the second sequence of second data samples; compute, by a second sequence machine learning model, based on the current data sample and the second state value: a second output value representing a second inference regarding the current data sample; and a second updated state value representing a learned embedding of the current data sample and the previous second data samples of the second sequence of second data samples; store the second updated state value in the data store; and output the second output value regarding the current data sample.

The data samples may correspond to transactions, the dimensions may include: a merchant identifier; and a credit card number, and the inference may correspond to a likelihood that the current data sample is a fraudulent transaction in the sequence of data samples having a same merchant identifier.

The second inference may correspond to a likelihood that the current data sample is a second fraudulent transaction in the second sequence of second data samples having a same credit card number.

The data samples may correspond to product selections, the dimensions may include: a consumer identifier; and a product identifier, and the inference may correspond to a likelihood that a consumer will select a product corresponding to the current data sample.

The non-transitory computer-readable medium may further store instructions that, when executed, cause the computer system to: receive an updated sequence machine learning model associated with a dimension; generate a plurality of updated state values corresponding to a plurality of sequences of data samples up until a cutoff time, each data sample in a sequence of data samples having a same value along the dimension associated with the updated sequence machine learning model; store the updated state values in the data store; deploy the updated sequence machine learning model to consume data samples from the cutoff time and to update the updated state values in the data store; and replace the sequence machine learning model with the updated sequence machine learning model as a provider of computed inferences.

The sequence machine learning model may include a recurrent neural network.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A method for computing a prediction using a machine learning model comprising:
receiving a current data sample of a sequence of data samples;
retrieving, from a data store, a state value representing a learned embedding of previous samples of the sequence of data samples;
computing, by a recurrent neural network, based on the current data sample and the state value:
an output value representing an inference regarding the current data sample; and
an updated state value representing a learned embedding of the current data sample and the previous samples of the sequence of data samples;
storing the updated state value in the data store; and
outputting the output value regarding the current data sample.

2. The method of claim 1, wherein the recurrent neural network is trained to compute state values representing learned embeddings of sequences of data samples and output values based on training sequences of training data samples and corresponding labels,
wherein the state value comprises a vector of numerical values in a multi-dimensional latent space.

3. The method of claim 1, wherein the data samples comprise a plurality of dimensions, and
wherein the data samples of the sequence of data samples and the current data sample have a same value in a first dimension.

4. The method of claim 3, further comprising:
determining a second sequence of second data samples having a same value as the current data sample in a second dimension of the plurality of dimensions;
retrieving, from the data store, a second state value representing a learned embedding of previous second data samples of the second sequence of second data samples;
computing, by a second recurrent neural network, based on the current data sample and the second state value:
a second output value representing a second inference regarding the current data sample; and
a second updated state value representing a learned embedding of the current data sample and the previous second data samples of the second sequence of second data samples;
storing the second updated state value in the data store; and
outputting the second output value regarding the current data sample.

5. The method of claim 4, wherein the data samples correspond to transactions,
wherein the dimensions comprise:
a merchant identifier; and
a credit card number, and
wherein the inference corresponds to a likelihood that the current data sample is a fraudulent transaction in the sequence of data samples having a same merchant identifier.

6. The method of claim 5, wherein the second inference corresponds to a likelihood that the current data sample is a second fraudulent transaction in the second sequence of second data samples having a same credit card number.

7. The method of claim 3, wherein the data samples correspond to product selections,
wherein the dimensions comprise:
a consumer identifier; and
a product identifier, and
wherein the inference corresponds to a likelihood that a consumer will select a product corresponding to the current data sample.

8. A system comprising:
a processor; and
memory storing instructions that, when executed, cause the processor to:
receive an updated sequence model associated with a dimension;
generate a plurality of updated state values corresponding to a plurality of sequences of data samples up until a cutoff time, each data sample in a sequence of data samples having a same value along the dimension associated with the updated sequence model;
store the updated state values in a sequence model state data store;
deploy the updated sequence model to consume data samples from the cutoff time and to update the updated state values in the sequence model state data store; and
replace a previous sequence model with the updated sequence model as a provider of computed inferences.

9. The system of claim 8, wherein the memory further stores instructions that, when executed, cause the processor to:
receive a current data sample of a sequence of data samples;
retrieve, from the sequence model state data store, a state value representing a learned embedding of previous samples of the sequence of data samples computed by the updated sequence model;
compute, by the updated sequence model, based on the current data sample and the state value:
an output value representing an inference regarding the current data sample; and
an updated state value representing a learned embedding of the current data sample and the previous samples of the sequence of data samples;
store the updated state value in the sequence model state data store; and
output the output value regarding the current data sample.

10. The system of claim 8, wherein the updated sequence model is trained to compute state values representing learned embeddings of sequences of data samples and output values based on training sequences of training data samples and corresponding labels,
wherein a state value of the state values comprises a vector of numerical values in a multi-dimensional latent space.

11. The system of claim 8, wherein the previous sequence model comprises a previous recurrent neural network and the updated sequence model comprises an updated recurrent neural network.

12. A non-transitory computer-readable medium storing instructions that, when executed, cause a computer system comprising a processing circuit to:
receive a current data sample of a sequence of data samples;
retrieve, from a data store, a state value representing a learned embedding of previous samples of the sequence of data samples;
compute, by a sequence machine learning model, based on the current data sample and the state value:
an output value representing an inference regarding the current data sample; and
an updated state value representing a learned embedding of the current data sample and the previous samples of the sequence of data samples;
store the updated state value in the data store; and
output the output value regarding the current data sample.

13. The non-transitory computer-readable medium of claim 12, wherein the sequence machine learning model is trained to compute state values representing learned embeddings of sequences of data samples and output values based on training sequences of training data samples and corresponding labels,
wherein the state value comprises a vector of numerical values in a multi-dimensional latent space.

14. The non-transitory computer-readable medium of claim 12, wherein the data samples comprise a plurality of dimensions, and
wherein the data samples of the sequence of data samples and the current data sample have a same value in a first dimension.

15. The non-transitory computer-readable medium of claim 14, further storing instructions that, when executed, cause the computer system to:
determine a second sequence of second data samples having a same value as the current data sample in a second dimension of the plurality of dimensions;
retrieve, from the data store, a second state value representing a learned embedding of previous second data samples of the second sequence of second data samples;
compute, by a second sequence machine learning model, based on the current data sample and the second state value:
a second output value representing a second inference regarding the current data sample; and
a second updated state value representing a learned embedding of the current data sample and the previous second data samples of the second sequence of second data samples;
store the second updated state value in the data store; and
output the second output value regarding the current data sample.

16. The non-transitory computer-readable medium of claim 15, wherein the data samples correspond to transactions,
wherein the dimensions comprise:
a merchant identifier; and
a credit card number, and
wherein the inference corresponds to a likelihood that the current data sample is a fraudulent transaction in the sequence of data samples having a same merchant identifier.

17. The non-transitory computer-readable medium of claim 16, wherein the second inference corresponds to a likelihood that the current data sample is a second fraudulent transaction in the second sequence of second data samples having a same credit card number.

18. The non-transitory computer-readable medium of claim 14, wherein the data samples correspond to product selections,
wherein the dimensions comprise:
a consumer identifier; and
a product identifier, and
wherein the inference corresponds to a likelihood that a consumer will select a product corresponding to the current data sample.

19. The non-transitory computer-readable medium of claim 12, further storing instructions that, when executed, cause the computer system to:
receive an updated sequence machine learning model associated with a dimension;
generate a plurality of updated state values corresponding to a plurality of sequences of data samples up until a cutoff time, each data sample in a sequence of data samples having a same value along the dimension associated with the updated sequence machine learning model;
store the updated state values in the data store;
deploy the updated sequence machine learning model to consume data samples from the cutoff time and to update the updated state values in the data store; and
replace the sequence machine learning model with the updated sequence machine learning model as a provider of computed inferences.

20. The non-transitory computer-readable medium of claim 12, wherein the sequence machine learning model comprises a recurrent neural network.
